(19) United States
(12) Patent Application Publication
(10) Pub. No.: US 2009/0188906 A1
(43) Pub. Date: Jul. 30, 2009

(54) HIGH-TEMPERATURE TUBE FURNACE FOR PYROLYSIS

(75) Inventors: Michael Bock, Bern (CH); Erich Dunker, Langen (DE)

Correspondence Address: DARBY & DARBY P.C., P.O. BOX 770, Church Street Station, New York, NY, 10008-0770, US

(73) Assignee: Stiftung Alfred-Wegener-Institut fuer Polar-und Meeresforschung, Bremerhaven (DE)

(21) Appl. No.: 12/360,968

(22) Filed: Jan. 28, 2009

(30) Foreign Application Priority Data
Jan. 29, 2008 (DE) 10 2008 007 354.7

(51) Int. Cl. F27B 5/14

(52) U.S. Cl. 219/390

(57) ABSTRACT

A high-temperature tube furnace for pyrolysis includes a twin-hole ceramic tube including a pyrolysis capillary concentrically arranged within a sintering heat tube which is concentrically arranged within a thermally insulated tube housing. At least one heating tube holding element that is electrically insulative and high-temperature resistant is provided and includes at least three pins disposed radially about the sintering heating tube. Each pin is mounted to the tube housing via a clamp in such a way that the pins are adjustable in the radial direction so that the sintering heating tube is removably disposed between the tips of the pins. The sintering heating tube is connected to a voltage source for applying a heating current to thereto.

### CROSS REFERENCE TO PRIOR APPLICATIONS

Priority is claimed to German Patent Application No. DE 10 2008 007 354.7, filed on Jan. 29, 2008, the entire disclosure of which is incorporated by reference herein.

### FIELD

The invention relates to a high-temperature tube furnace for pyrolysis, having a concentric arrangement consisting of a tube housing, thermal insulation, a sintering heating tube mounted in electrically insulating and high-temperature-resistant heating-tube holding elements, a mounted twin-hole ceramic tube and a pyrolysis capillary, whereby a heating current stemming from a voltage source is applied to the sintering heating tube.

### BACKGROUND

Many substances first have to undergo a decomposition reaction before their products can be examined with modern and sensitive detectors. This decomposition can be carried out by means of pyrolysis. The term “pyrolysis” refers to the breakdown of liquid or gaseous substances by applying thermal energy at temperatures between 1000° C. and 1500° C. [1832° F. and 2732° F.] in the absence of oxygen. An oxygen-free atmosphere can be established in a reactor chamber that is heated externally and through which a carrier-gas stream with an analyte or an undiluted substance to be pyrolysed is flowing. For instance, methane can be separated from other components in the air by means of gas chromatography and it can then be conveyed through a pyrolysis reactor in a continuous carrier-gas stream (e.g., helium). This process gives rise to elementary carbon, which accumulates in the pyrolysis capillary, and hydrogen, whose isotopic composition can subsequently be analyzed with an isotope ratio mass spectrometer. This allows conclusions to be drawn about the various sources of atmospheric methane (for example, trapped in drilled ice cores that are 100,000 years old or more). The reactor chamber can be heated by heating gases or else with electric heating systems. When reactor capillaries are employed, a cost-effective option is to use so-called “tube furnaces” which allow the pyrolysis to be carried out as a heat treatment under conditions that can be controlled well.

A high-temperature tube furnace is sold by the Thermo Fisher Scientific company under the designation “Finnigan GC-C/TC III” (Gas Chromatography Temperature Conversion) and is described in a company brochure dated from 2004, available as BR 30033_E 06/04. This prior-art high-temperature tube furnace for pyrolysis, whose dimensions are less than half a meter, is easy to handle and it has a concentric arrangement of various tubes. A pyrolysis capillary runs through the center. The pyrolysis capillary is arranged in a twin-hole ceramic tube in the form of a massive ceramic tube having two axial passage openings. In the second passage opening, the twin-hole ceramic tube can also accommodate a thermoelement for temperature control. The pyrolysis capillary and the twin-hole ceramic tube are heated by a sintering heating tube through which an electric heating current can flow, said tube heating up to a temperature of about 1430° C. [2606° F.]. For this purpose, the twin-hole ceramic tube is sheathed by the sintering heating tube in such a way as to make contact with it, as a result of which the twin-hole ceramic tube is held and affixed. No other means to hold the twin-hole ceramic tube is provided. On the outside, the sintering heating tube is surrounded by ceramic fibers in such a way that they make contact with it and create thermal insulation. This insulation extends all the way to the tube housing that closes off the concentric structure. At both of its ends, the sintering heating tube is mounted in electrically insulating and high-temperature-resistant heating-tube holding elements. These are non-flexible bearings made of ceramic rings. The rings are inserted into one of the ends of the tube housing so as to close it off.

The arrangement of the sintering heating tube in such a way that it makes contact with the twin-hole ceramic tube and with the thermal insulation gives rise to hot spots that greatly limit the service life of the heating tube. The replacement of defective sintering heating tubes in the prior-art tube furnaces is problematic because the sintering heating tubes are mounted in the heating-tube holding elements by means of ceramic rings whose dimensions are precisely adapted to the dimensions of the sintering heating tube. However, owing to the sintering production process, the sintering heating tubes can only be manufactured with relatively large tolerances. Therefore, any replacement of the sintering heating tube makes it necessary to replace the heating-tube holding elements as well. Consequently, the entire replacement process becomes so laborious that preference is given to using a completely new tube furnace. As a result, the manufacturer typically only offers a completely new tube furnace which is much more expensive than a sintering heating tube.

The voltage supply for generating the heating current for the sintering heating tube consists of a transformer in which the voltage can be varied by switching between 40 V and 80 V by (variable-voltage transformer). The voltage has to be increased because the electric resistance of the sintering heating tubes (silicon carbide SiC) rises as they age. In order to be able to achieve the desired output and thus the temperature needed for the pyrolysis, the applied voltage has to be raised repeatedly (and discretely, in other words, with switch-off procedures). The discontinuous operation, however, likewise stresses the sintering heating tube and accelerates the demise of the system. Additionally, in the prior tube furnaces, the twin-hole ceramic tube does not have its own holding element, it is simply inserted into the sintering heating tube (SiC) in such a way that it makes contact, and this causes hot spots on the inside of the sintering heating tube.

### SUMMARY

In an embodiment, the present invention provides a high-temperature tube furnace for pyrolysis, wherein a sintering heating tube, which is connected to a voltage source for the application of a heating current, is concentrically disposed in a thermally insulated tube housing. A twin-hole ceramic tube including a pyrolysis capillary is concentrically disposed in the sintering heating tube. At least one heating tube holding element that is electrically insulative and high-temperature resistant is provided. The heating tube holding element includes at least three pins disposed radially about the sintering heating tube, each pin having a tip facing the sintering heating tube. At least three clamps connected to the tube housing are also provided. Each of the clamps is configured to receive a respective one of the at least three pins so that the respective pin is adjustable in a radial direction so as to removably dispose the sintering heating tube between tips of the pins.

### BRIEF DESCRIPTION OF THE DRAWINGS

Other features and advantages of various embodiments of the tube furnace for pyrolysis according to the present invention will become apparent by reading the following detailed description with reference to the attached drawings which illustrate the following:

FIG. 1 shows a longitudinal section through a high-temperature tube furnace (in detail); and

FIG. 2 shows a front view of a high-temperature tube furnace.

### DETAILED DESCRIPTION

According to an embodiment of the present invention, a high-temperature tube furnace for pyrolysis of the above-mentioned generic type is provided with which the sintering heating tube can easily be replaced. Additionally, it is possible to virtually avoid the occurrence of hot spots and to ensure a gentle supply of voltage. Both measures account for a considerably longer service life for the sintering heating tube. These and other advantageous refinements will be explained in greater detail below in conjunction with the invention.

In the tube furnace according to an embodiment of the present invention, each thermally insulating and high-temperature-resistant heating-tube holding element consists of at least three ceramic pins that are arranged radially and that can also be affixed so as to move radially. Preferably, a heating-tube holding element is provided at each end of the tube furnace. Each ceramic pin is mounted in a clamp that is fastened to the tube housing. The sintering heating tube is mounted between the tips of the ceramic pins. Any position of the sintering heating tube around the tube furnace central axis, which lies approximately at the virtual point of intersection of the radial ceramic pins, can be set by means of three radial ceramic pins. The above-mentioned measures make it possible to easily replace the sintering heating tube by loosening the clamps and removing the ceramic pins. Because the ceramic pins are adjustable radially, a new sintering heating tube having different diameters can be centered again with precision. Therefore, production-related differences in the diameter of the sintering heating tube can be compensated for without any problem.

The at least three clamps of a heating-tube holding element are preferably mounted in a housing cover that has recesses for the ceramic pins and that closes off the tube housing so as to be centered. The clamps can be mounted easily and removably to the housing cover. Correspondingly, two housing covers may be provided when two heating-tube holding elements are employed. These also ensure that the tube furnace is closed off at both ends, so that the generated heat cannot escape. Moreover, it becomes even easier to replace the heating tube if the clamps have threaded connections for affixing the ceramic pins and for mounting them in the housing cover. For example, one threaded connection with a single screw can be provided for each ceramic pin. The clamp is opened by loosening the screw and the ceramic pin can be moved radially. Tightening the screw not only secures the ceramic pin in the clamp but also affixes the clamp on the housing cover. Moreover, the sintering heating tube can be axially adjusted. Preferably, for each heating-tube holding element, three ceramic pins are arranged at an angle of about 120° with respect to each other to provide for axis adjustments. Precise axis adjustment is especially important when the sintering heating tube is configured as a silicon carbide sintering element since the production process gives rise to relatively large deviations in the diameter.

The above-mentioned measures serve to ensure that the sintering heating tube can be easily replaced in the tube furnace according to an embodiment of the present invention so that defective sintering heating tubes can be replaced and the tube furnace can continue to operate. The handling can also be improved by preventing the sintering heating tubes from frequently becoming defective. Sintering heating tubes are damaged by the occurrence of hot spots and by discontinuous operation. Hot spots are localized sites of overheating that occur due to the direct contact of the sintering heating tube with other components, such as the twin-hole ceramic tube and the insulation.

According to an embodiment of the present invention, a first measure to avoid hot spots consists of no longer mounting the twin-hole ceramic tube directly in the sintering heating tube, but rather, providing a discrete mounting of the twin-hole ceramic tube without contact being made with the sintering heating tube. For this purpose, the twin-hole ceramic tube is preferably mounted in tube holding elements that are configured as centering stars secured to the tube housing. Here, the twin-hole ceramic tube is mounted so as to create a second concentric air gap with respect to the sintering heating tube. This reliably prevents contact between the twin-hole ceramic tube and the sintering heating tube, and thus the occurrence of hot spots. Preferably, a centering star is also arranged at each end of the tube furnace, so that the twin-hole ceramic tube is likewise mounted in two holding elements. With the tube furnace according to an embodiment of the present invention, the twin-hole ceramic tube is first centered by the radial ceramic pins, then the twin-hole ceramic tube is aligned in the axis of the sintering heating tube using the centering star, so that no contact points are created between the sintering heating tube and the ceramic tube. Preferably, each centering star can have three support ribs arranged at an angle of about 120° with respect to each other radially or at an angle relative to the radial plane, said twin-hole ceramic tube being mounted in the point of intersection of said support ribs. Analogously to the mounting of the sintering heating tube in a tripod consisting of ceramic pins, a centering star having three support ribs at an angle of 120° is preferable for its support and strength characteristics. The centering star may be likewise supported on the tube housing. Consequently, the holding elements of the sintering heating tube and of the twin-hole ceramic tube may be both supported on the tube housing, but independently of each other. Moreover, the twin-hole ceramic tube can be fitted with a thermoelement in the second axial passage opening since the mounting in the two centering stars allows this without any problem.

Moreover, no points of contact are created between the sintering heating tube and the insulation when the insulation is configured as an insulating sheath on the inside of the tube housing, thus creating a concentric air gap with respect to the heating tube. The air gap prevents any contact and thus the occurrence of hot spots on the outside of the sintering heating tube. Furthermore, it serves as additional thermal insulation. Preferably, the insulating sheath is made of ceramic fiber material that is arranged between the tube housing and a concentric inner tube to provide superior and well-defined insulation. Such ceramic fiber material is highly fireproof and withstands continuous temperatures of 1500° C. [2732° F.]. The inner tube preferably consists of a cylindrical perforated plate made of stainless steel. In this manner, a double-walled tube structure is created with insulation between the two concentric housings.

The service life of the sintering heating tube can be further improved by employing a voltage source different from the type used in the prior art. With the voltage sources of the prior art, the voltage has to be increased during operation due to ageing of the SiC elements. The furnace has to be switched off for this purpose in order to switch the transformer to the next higher voltage stage. At an operating temperature of more than 1000° C. [1832° F.], however, SiC elements attain their longest service life if they are operated continuously. Thus, it is preferable to provide a continuously adjusted voltage supply that does not require any interruptions during operation according to an embodiment of the present invention. Preferably, this may be achieved by a voltage supply that is effectuated by means of a power converter that generates a pulsed direct voltage and by means of a temperature regulator that receives the value of the actual temperature from the thermoelement. The power transformer can be, for example, the “JUMO IPC IGBT power converter” (manufactured by the JUMO company, specification sheet 70.9050, 08.06/00389002), which serves to control the thermal loads that, up until now, have required a transformer (variable-voltage transformer or a combination of a thyristor power controller with a transformer). Because of its mode of operation, an electronic transformer with a pulsating direct voltage at the output may be provided. Such a transformer combines the advantages of a conventional variable-voltage transformer such as, for instance, amplitude regulation and sinusoidal network load, with the advantages of a thyristor circuit breaker such as, for example, current limitation, load monitoring and subordinated regulating operations. According to an embodiment of the present invention having such a voltage supply, a gentle supply of electricity to the sintering heating tube may be ensured. The increase in the electric resistance of the sintering heating tube caused by ageing may be continuously compensated for, and there are no interruptions in the operation that would involve cooling off and subsequent heating up of the sintering heating tube.

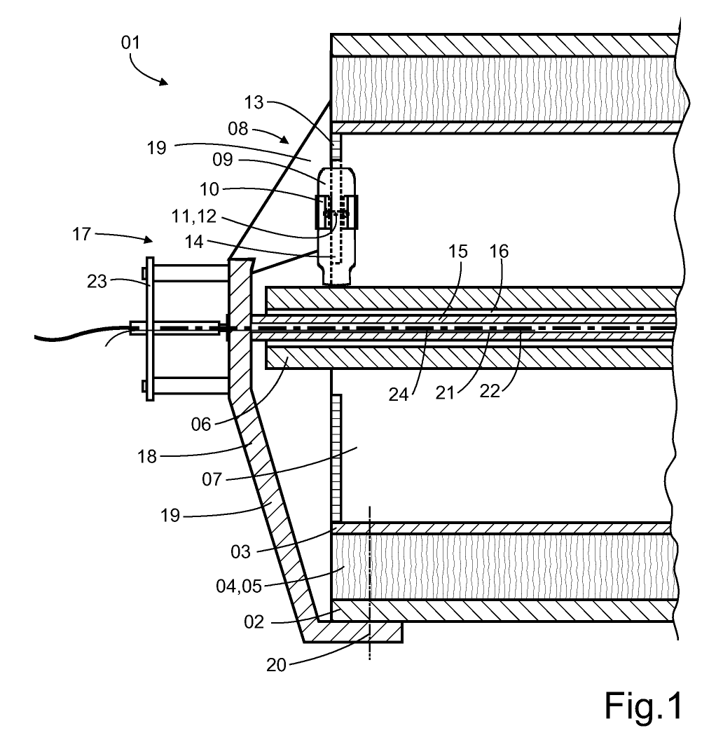

FIG. 1 shows a longitudinal section (in detail in the area of one end of the furnace) through a high-temperature tube furnace 01 for pyrolysis, having a tube housing 02 that is closed off towards the outside. A concentric arrangement of additional tubes is located inside this housing. Thermal insulation 04 is provided between an inner tube 03 and the tube housing 02. This insulation is preferably configured as an insulating sheath 05 made of ceramic fibers. The inner tube 03 consists of a cylindrical perforated plate made of stainless steel. A first concentric air gap 07 is provided with respect to a sintering heating tube 06 made, for example, of silicon carbide SiC, which not only ensures additional insulation of the sintering heating tube 06, but also prevents hot spots caused by contact between the insulation 04 and the sintering heating tube 06.

The sintering heating tube 06 is mounted in two electrically insulating and high-temperature-resistant heating-tube holding elements 08 at both ends of the tube housing 02. In the illustrated embodiment, each of the two heating-tube holding elements 08 consists of three ceramic pins 09 arranged radially at an angle of 120° relative to each other. Each ceramic pin 09 is mounted in a clamp 10 so as to move radially. Each clamp 10 is affixed to a housing cover 13 by means of a threaded connection 11 having, for instance, a single screw 12. The housing cover 13 may be provided with recesses 14 for the ceramic pins 09 and closes off the tube housing 02 so as to be centered. The threaded connection 11 also serves to clamp the ceramic pins 09. The sintering heating tube 06 is mounted so as to be centered at the point of intersection of the three ceramic pins 09. Additionally, it is easy to make a production-related adaptation to any outer diameter of the sintering heating tube 06 that might become necessary following a replacement.

The sintering heating tube 06 is replaced after the threaded connections 11 have been loosened and the ceramic pins 09 have been radially retracted. Prior to this, a centering star 18 (see below) is unscrewed from one end of the furnace. After the new sintering heating tube 06 has been inserted, the ceramic pins 09 are pushed against the sintering heating tube 06, the latter is properly centered and the threaded connections 11 are tightened. Subsequently, the centering star 18 is put in place and secured, e.g., screwed in place.

A twin-hole ceramic tube 15 is arranged concentrically on the inside of the sintering heating tube 06. A second concentric air gap 16 remains between the two tubes 06, 15, so that here as well, no hot spots can occur due to contact. However, the second air gap 16 is so small that heat can be transmitted relatively well from the sintering heating tube 06 to the twin-hole ceramic tube 15. The twin-hole ceramic tube 15 is concentrically mounted by means of a central receiving hole 17 in the centering star 18 at both ends of the tube housing 02. Each centering star 18 is secured to the tube housing 02 so as to be centered, so that the centrally-disposed twin-hole ceramic tube 15 is mounted in such a way that the second concentric air gap 16 is formed with respect to the sintering heating tube 06. In the selected embodiment, each centering star 18 consists of three support ribs 19 arranged at an angle of 120°, in whose point of intersection the central receiving hole 17 for the twin-hole ceramic tube 15 is arranged. Furthermore, the three support ribs 19 are arranged at an angle relative to the radial plane of the tube furnace 01, resulting in a forward positioning of the mounting of the twin-hole ceramic tube 15 on both sides of the tube housing 02 in front of the housing cover 13. The centering stars 18 are supported on the tube housing 02 and are affixed by additional threaded connections 20. This threaded connection 20 also affixes the housing cover 13. Such a flush closure is preferable so that only a minimal amount of convection heat can escape from the tube furnace 01 towards the front or back.

The pyrolysis capillary 22 is mounted in one of the two passage openings 21 of the twin-hole ceramic tube 15. The pyrolysis capillary 22 is mounted in two bridge holding elements 23 that are affixed to the centering stars 18. In the embodiment shown, a coupler for pyrolysis capillaries 22 is attached to this bridge holding element 23 on a gas-chromatographic column. This is where, for example, the substance of interest, methane, is separated from the other air components, namely, nitrogen, oxygen, argon and carbon dioxide. For example, methane is conveyed in the carrier gas helium in the pyrolysis capillary 22 and then pyrolytically cleaved at about 1430° C. [2606° F.]. The temperature is preferably controlled by means of a thermoelement 24 located in the second passage opening 21 of the twin-hole ceramic tube 15 and regulated by a temperature regulator that is connected to a voltage supply (not shown in greater detail in FIG. 1). The cleavage products are subsequently examined, for example, by means of mass spectrometry, in order to determine the hydrogen content, for example, when an analysis for methane is carried out.

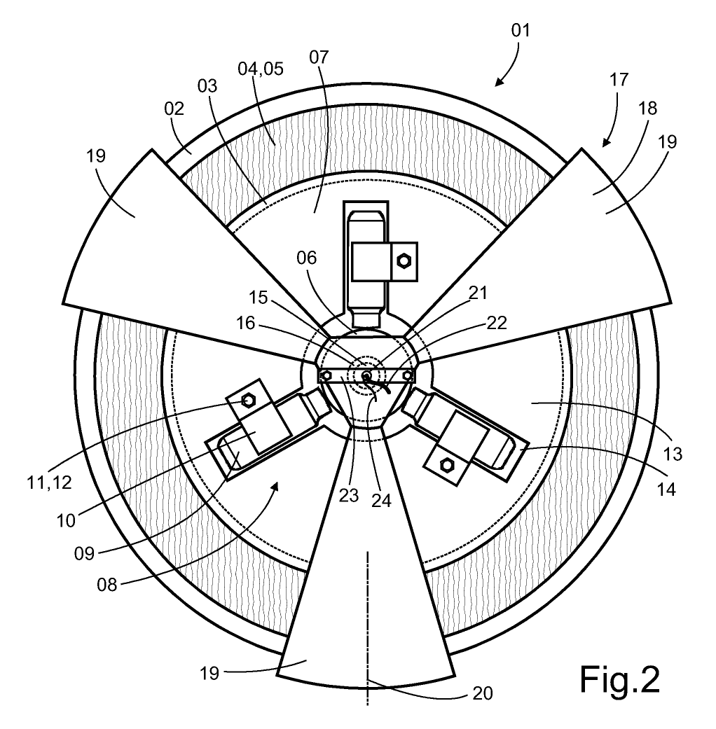

FIG. 2 shows a front view of the high-temperature tube furnace 01. The same reference numerals as in FIG. 1 are used to designate similar components. The high-temperature tube furnace 01 comprises the tube housing 02 that closes off towards the outside, the inner tube 03 and, between them, the thermal insulation 04 in the form of an insulating sheath 05 made of, e.g., ceramic fibers. A first concentric air gap 07 is formed with respect to the sintering heating tube 06 that is mounted in two insulating heating-tube holding elements 08 at both ends of the tube housing 02. The insulating heating-tube holding elements 08 each consist of three ceramic pins 09 having a clamp 10 that, by means of a threaded connection 11 having a screw 12, can be mounted and affixed to a housing cover 13 having a recess 14 for the ceramic pins 09 so as to be radially movable. The sintering heating tube 06 is mounted so as to be centered at the point of intersection of the ceramic pins 09.

The twin-hole ceramic tube 15 is arranged concentrically on the inside of the sintering heating tube 06, whereby a second concentric air gap 16 remains. The concentric mounting of the twin-hole ceramic tube 15 is achieved by means of two central receiving holes 17 at both ends of the tube housing 02. Each tube holding element 17 is configured as a centering star 18 consisting of three support ribs 19. The centering stars 18 are supported on the tube housing 02 and are affixed by additional threaded connections 20. This threaded connection 20 also centers the housing cover 13 on both sides of the tube furnace 01.

The pyrolysis capillary 22 is located inside the twin-hole ceramic tube 15, mounted in two bridge holding elements 23 on the centering stars 18. The temperature next to the pyrolysis capillary 22, which is located in the first passage opening 21 of the twin-hole ceramic tube 15, is measured by means of the thermoelement 24 that is located in the second passage opening 21 in the twin-hole ceramic tube 15.

While the invention has been particularly shown and described with reference to preferred embodiments thereof, it will be understood by those skilled in the art that various changes in form and details may be made therein without departing from the spirit and scope of the invention.

1. A high-temperature tube furnace for pyrolysis, comprising:
a tube housing including thermal insulation;
a sintering heating tube disposed concentrically in the tube housing and electrically connected to a voltage source for applying a heating current to the sintering heating tube;
a twin-hole ceramic tube disposed concentrically in the sintering heating tube and including a pyrolysis capillary;
at least one heating tube holding element that is electrically insulative and high-temperature resistant and includes at least three pins disposed radially about the sintering heating tube, each pin having a tip facing the sintering heating tube; and
at least three clamps connected to the tube housing, each of the clamps being configured to receive a respective one of the at least three pins so that the respective pin is adjustable in a radial direction so as to removably dispose the sintering heating tube between tips of the pins.

2. The high-temperature tube furnace according to claim 1, wherein the pins are ceramic.

3. The high-temperature tube furnace according to claim 1, wherein the clamps are attached to a housing cover which closes off the tube housing and includes recesses for the pins.

4. The high-temperature tube furnace according to claim 3, wherein the clamps include threaded connections for affixing the pins and for mounting the clamps to the housing cover.

5. The high-temperature tube furnace according to claim 1, wherein the pins are arranged about the tube housing at an angle of 120 degrees with respect to each other.

6. The high-temperature tube furnace according to claim 1, wherein the sintering heating tube includes a silicon carbide sintering element.

7. The high-temperature tube furnace according to claim 1, further comprising a centering star affixed to the tube housing, the centering star having a central receiving hole configured to receive the twin-hole ceramic tube so as to form a concentric air gap between the twin-hole ceramic tube and the sintering heating tube.

8. The high-temperature tube furnace according to claim 7, wherein the centering star includes three support ribs extending radially outward from the central receiving hole at an angle of 120 degrees with respect to each other.

9. The high-temperature tube furnace according to claim 8, wherein the support ribs are inclined with respect to the end face of the tube housing.

10. The high-temperature tube furnace according to claim 1, wherein the pyrolysis capillary is disposed in a first passage opening of the twin-hole ceramic tube, and wherein the twin-hole ceramic tube includes a thermoelement disposed in a second passage opening thereof.

11. The high-temperature tube furnace according to claim 1, wherein the thermal insulation includes an insulating sheath disposed on an inner face of the tube housing so as to form a concentric air gap between the thermal insulation and the sintering heating tube.

12. The high-temperature tube furnace according to claim 11, further comprising an inner tube concentrically disposed within the tube housing between the insulating sheath and the concentric air gap.

13. The high-temperature tube furnace according to claim 11, wherein the insulating sheath includes a ceramic fiber material.

14. The high-temperature tube furnace according to claim 12, wherein the inner tube includes a cylindrical perforated stainless steel plate.

15. The high-temperature tube furnace according to claim 3, wherein the housing cover is disposed centered on the tube housing.

16. The high-temperature tube furnace according to claim 10, wherein the voltage supply includes a power converter which generates a pulsed direct voltage and a temperature regulator which receives an actual temperature value from the thermoelement.
